(19) United States
(12) Patent Application Publication
(10) Pub. No.: US 2005/0169809 A1
(43) Pub. Date: Aug. 4, 2005

(54) Device for producing a cytological preparation on an object-carrying slide

(76) Inventors: Jean-Luc Centeleghe, Mont-sur-Lausanne (CH); Lorenzo Balli, Mont-sur-Lausanne (CH)

Correspondence Address: NIXON & VANDERHYE, PC, 901 NORTH GLEBE ROAD, 11TH FLOOR, ARLINGTON, VA, 22203, US

(21) Appl. No.: 10/512,565

(22) PCT Filed: Feb. 10, 2003
(86) PCT No.: PCT/CH03/00097

(30) Foreign Application Priority Data
Apr. 24, 2002 (CH) 700/02

(51) Int. Cl. B01L 11/00

(52) U.S. Cl. 422/101; 436/177

(57) ABSTRACT

The invention concerns a device (1) for producing a cytological preparation on an object-carrying slide (2) from a sample in the form of a suspension of cells, said device comprising a receptacle (3) for holding a suspension of cells, the base (4) of said receptacle being connected to a suction/filtration system including a filtering membrane (5), a support (6) for said membrane and suction means. The invention is characterized in that it comprises means for sucking/filtering a predetermined fraction of a suspension of cells held in the container.

### FIELD OF THE INVENTION

The present invention relates to a device for producing a cytological preparation on an object-carrying slide from a sample in the form of a suspension of cells. The device comprises a receptacle for holding a suspension of cells, the base of said receptacle being connected to a suction/filtration system comprising a filtering membrane, a support for said membrane and suction means.

### STATE OF THE ART

A device such as the one mentioned above serves to automate the production of a cytological preparation on an object-carrying slide from a sample in the form of a suspension of cells, while at the same time improving its quality.

In fact, such a preparation is of value for observation under a microscope only if the cells are placed on the slide in an appropriate manner, i.e. they are separated from one another in sufficient but not excessive number, and they are not damaged.

Since the starting suspensions exhibit great variation in the concentration of cells (cell/ml), it is useful to have a device that adapts to this concentration so as to provide quality preparations.

U.S. Pat. No. 4 395 493 from Coulter Electronics, Inc. provides a device for producing a cytological preparation on an object-carrying slide from a sample in the form of a suspension of cells.

The device comprises a pressure source which is intended to induce a flow of the suspension from a first receptacle toward a second receptacle, the pathway being equipped with a cell counter. When the second receptacle receives said suspension of cells, it is placed in contact with a fraction of a filtering membrane tape. During this time, a vacuum is applied across the filter so as to retain on the latter only the filtrate. Once the suspension has been filtered, the fraction of tape loaded with filtrate is moved toward a press which transfers said filtrate from the filtering membrane tape to an object-carrying slide.

This complex device has the disadvantage of having several elements which carry the suspension between the first receptacle and the filtering membrane receiving the filtrate. Consequently, all these elements are contaminated during a cytological preparation. As a result, the cleaning between each cytological preparation must be very substantial, which requires time and great expense.

U.S. Pat. No. 5 143 627 from Cytyc Corporation provides a device for producing a cytological preparation on an object-carrying slide from a sample in the form of a suspension of cells. The device comprises a filtering device which is immersed in the suspension of cells.

This device, firstly, has to undergo substantial cleaning between each preparation, this being due to the complexity of functioning of said device, and it, secondly, is provided for test laboratories which regularly have a large number of samples to prepare. In fact, since this device is relatively complex, it is expensive.

European patent application EP 743 524 from Costar Italia S.r.l. also provides a device for producing a cytological preparation on an object-carrying slide from a sample in the form of a suspension of cells.

Despite the fact that this device resembles overall, by virtue of its simplicity and its arrangement, the device of the present invention, it is not, for its part, developed enough for producing object-carrying slides that are consistent and of quality. In fact, it does not for example allow the filtration of a predetermined fraction of a suspension of cells, which means that the operator has to pipette the exact amount that he or she wants to use for the preparation. Furthermore, this device does not disclose any system for transferring the filtrate from the filtering membrane to the object-carrying slide, the transfer essentially being carried out manually, which is no guarantee of quality or of consistency.

### SUMMARY OF THE INVENTION

The present invention has the virtue of remedying in particular the above-mentioned problems by offering a simple device for making available, at moderate cost, a functional device for small to moderate-scale laboratories.

More precisely, the invention relates to a device for producing a cytological preparation on an object-carrying slide from a sample in the form of a suspension of cells, said device comprising a receptacle for holding a suspension of cells, the base of said receptacle being connected to a suction/filtration system comprising a filtering membrane, a support for said membrane and suction means, characterized in that it comprises means for suctioning/filtering a predetermined fraction of a suspension of cells held in the receptacle.

The operator responsible for producing a cytological preparation observes the sample received in the form of a suspension of cells. According to the degree of opacity of the suspension, which corresponds to the cell concentration of the sample, the operator defines the fraction of the suspension intended to be prepared. Thus, for example, if the suspension is normal (clear or slightly cloudy), the operator defines a fraction of 6 ml. If the suspension is very opaque (cell density too high), the operator defines a fraction of 3 ml.

The device according to the invention may comprise a pivoting system constituted so as to allow the receptacle and/or the filtering membrane to pivot. The pivoting of the receptacle, along with the filtering membrane, serves to recover the surplus of suspension after suction/filtration of the predetermined fraction of suspension. The suspension can be recovered in the original flask which contained the sample to be analyzed; as a result, other analyses can be carried out on the same sample. Other means for recovering the suspension by tipping the receptacle can be provided.

The pivoting system can also allow the transfer of the filtrate contained on the filtering membrane to the object-carrying slide. This additional means makes it possible to produce consistent preparations of quality, considering that manual transfer of the filtrate onto an object-carrying slide depends greatly on the work of the operator. Thus, for example, some cells will be damaged if the operator performs a sideways movement when the filtering membrane touches the object-carrying slide.

The device according to the invention can comprise a slide-carrying support arranged such that the membrane is positioned above subsequent to it being tipped.

The device according to the invention can also have means for injecting air in order to detach the membrane from its support and/or to attach the membrane to a slide which is on the object-carrying slide support, once the membrane is positioned on the object-carrying slide support.

A mass can be provided for pressing the filtrate of the suspension onto a slide placed on the object-carrying slide support. This element allows better adhesion of the filtrate to the slide. Means can also be provided for applying this mass to the slide for a predetermined period of time and for removing the mass automatically once said period of time has come to an end.

These means are useful for relieving the operator who thus does not have to be present to time the necessary period of time and to remove the mass. The preset period of time is advantageously around 20 seconds.

The mass may comprise a component that is detachable so as to be able to use, where appropriate, a lighter mass. It has in fact been noted that the mass for producing an optimum preparation is around 150 g for gynecological preparations and around 50 g for other preparations.

The receptacle, an element of the invention, is preferably of frustoconical shape, its cross section decreasing toward the base, the base comprising an opening bordered on its external face by a protrusion intended to ensure a leak-tight contact between the receptacle and the suction system.

It has in fact been noted that a slightly frustoconical shape allows a better flow of the suspension toward the opening present on the base of the receptacle.

Furthermore, said protrusion intended to ensure a leak-tight contact between the receptacle and the suction system provides an improvement with respect to the receptacle of European application EP 743 524 from COSTAR ITALIA S.r.l., which is not sufficiently leak-tight.

A system for conveying a fixing product into the receptacle can be provided in the present device. Thus, the cytological preparation obtained is ready to use as soon as the transfer of the filtrate to the object-carrying slide has taken place.

The set of devices can be arranged on the same piece of apparatus.

The device or set can be included in a box equipped with a cover.

The production of a cytological preparation on an object-carrying slide from a sample in the form of a suspension of cells is obtained by means of the following process, which comprises a step during which a suspension is poured into a receptacle and then suctioned/filtered through a filtering membrane placed on a support via an opening placed on the base of the receptacle, said process being characterized in that a predetermined fraction of the suspension of cells held in the receptacle is suctioned/filtered.

Prior to the suction/filtration, a fixing product can be introduced into the suspension held in the receptacle.

Subsequent to the suction/filtration, the receptacle can be pivoted and its contents recovered in recovering means.

After having removed the receptacle, the membrane can be pivoted so as to be positioned on an object-carrying slide which is on its support.

In order to detach the membrane from its support and/or to attach the membrane to the slide, air can be injected.

Next, a mass can be applied to the membrane for a predetermined period of time in order to improve its adhesion to the slide; the mass can be automatically removed once the predetermined period of time has come to an end.

Moreover, the activation of the mass can trigger the cleaning of the membrane support.

A preferred embodiment is described below in greater detail for a better understanding/illustration of the invention. This embodiment does not, however, in any way limit the scope of the invention.

### BRIEF DESCRIPTION OF THE FIGURES

A nonlimiting embodiment of the invention is described below by means of the following figures:

FIGS. 1, 2, 3 and 4 illustrate a perspective view of the device according to the invention at various steps of the functioning thereof.

FIGS. 5, 6 and 7 illustrate a front view of the means for applying the mass onto the object-carrying slide.

FIGS. 8 and 9 illustrate a perspective view of the receptacle for holding a suspension of cells. FIG. 8 illustrates a view from above, whereas FIG. 9 illustrates a view from below showing the base of the receptacle.

Each element common to each figure bears the same numerical reference.

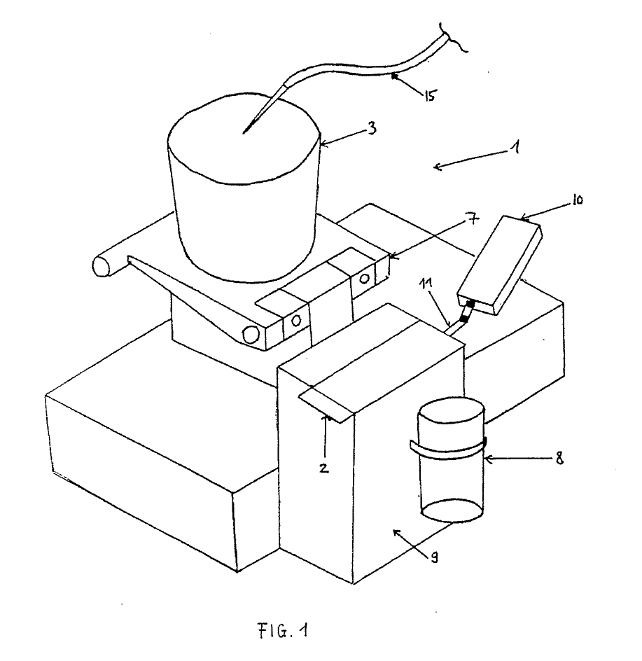

FIG. 1 illustrates the device (1) according to the invention comprising an object-carrying slide (2) placed on an object-carrying slide support (9). A means for recovering the suspension (8) is attached to a face of said support (9). The device also comprises a mass (10) and means for applying the mass (11) onto the object-carrying slide (2). A pivoting system (7) makes it possible to pivot the receptacle (3) and/or the filtering membrane (not visible on this figure). The device is equipped with a system for conveying a fixing product (15). This figure illustrates the step in which a suspension of cells can be poured into the receptacle (3) in order to be suctioned/filtered through a filtering membrane (not visible on this figure).

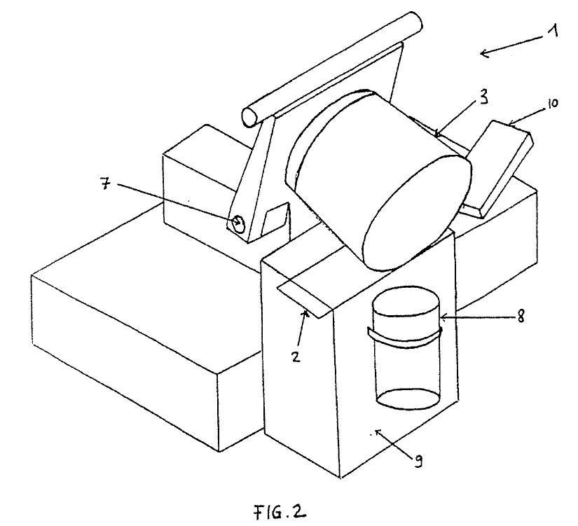

FIG. 2 illustrates the device (1) according to the invention during the step consisting in pivoting the receptacle (3) after suction/filtration of the suspension. The aim of this step is to recover the content of the receptacle in recovering means (8).

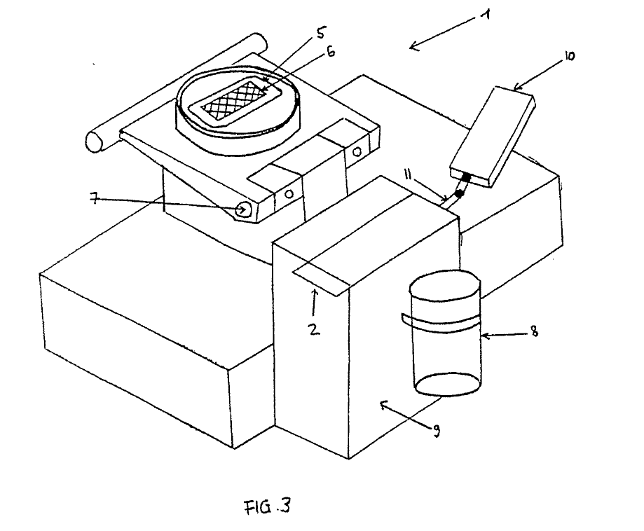

FIG. 3 illustrates the device (1) according to the invention during the following step, during which the empty receptacle (3) has been removed and the pivoting system (7) has been returned to the horizontal position. The filtering membrane (5) and its support (6) are now visible.

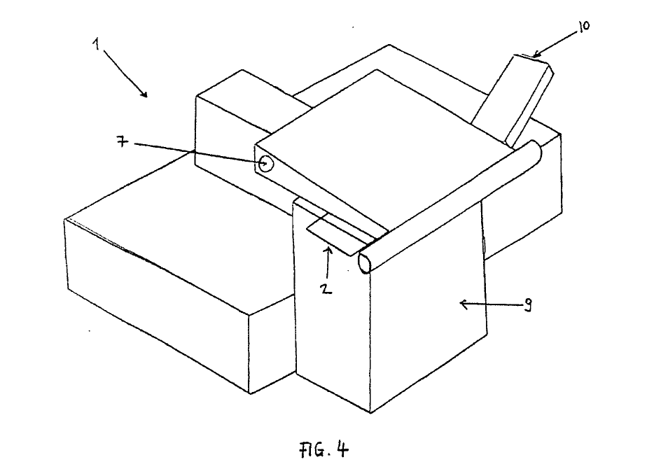

FIG. 4 illustrates the device (1) according to the invention during the following step, during which the filtering membrane (not visible on this figure) is pivoted by means of the pivoting system (7) so as to be positioned on the object-carrying slide support (9). At this stage, air is injected so as to detach the membrane from its support and/or attach the membrane to the slide.

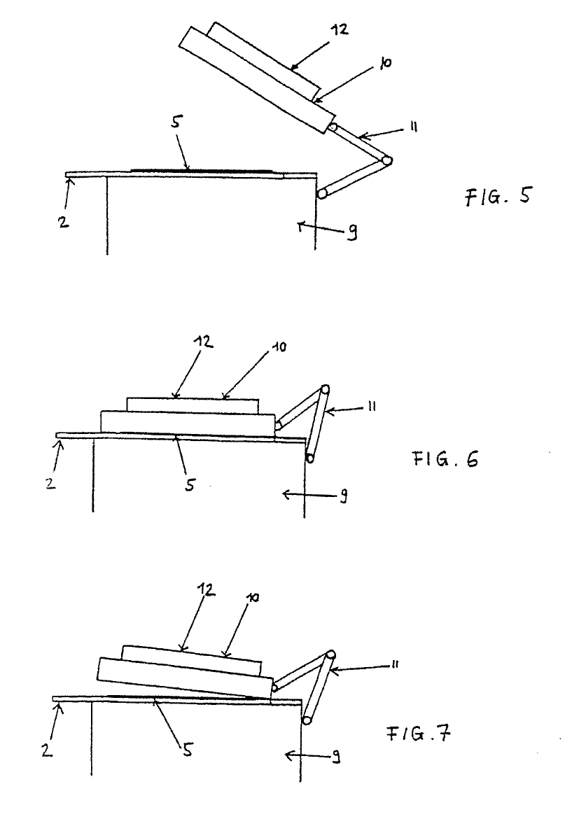

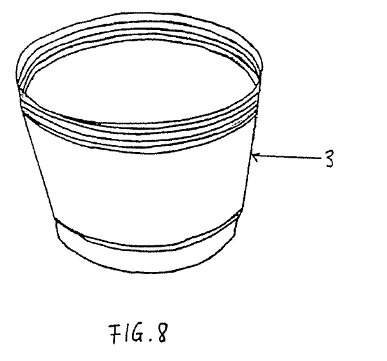

FIGS. 5 to 7 illustrate the following step, which consists in applying a mass (10) onto the membrane (5) for a given period of time. FIG. 5 represents the position before application of the mass, FIG. 6 during application of the mass and FIG. 7 after automatic removal of the mass. The mass can be equipped with a detachable component (12).

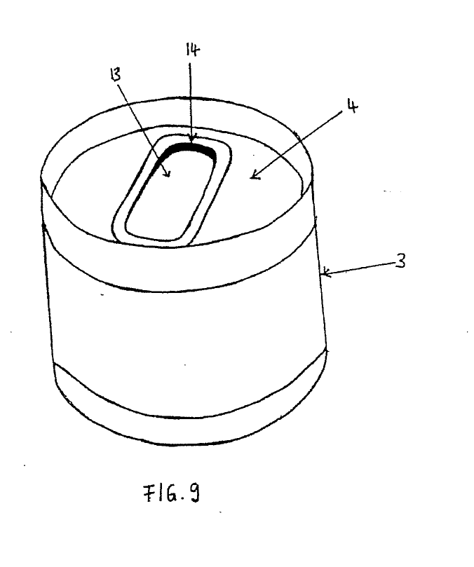

FIG. 8 illustrates the frustoconical receptacle (3) according to the invention.

FIG. 9 illustrates the receptacle (3) according to the invention comprising a base (4) equipped with an opening (13) bordered on its external face by a protrusion (14).

1. A device (1) for producing a cytological preparation on an object-carrying slide (2) from a sample in the form of a suspension of cells, said device comprising a receptacle (3) for holding a suspension of cells, the base (4) of said receptacle being connected to a suction/filtration system comprising a filtering membrane (5), a support (6) for said membrane and suction means,
characterized in that it comprises means for suctioning/filtering through the membrane a predetermined fraction of a suspension of cells held in the receptacle, said fraction corresponding to the amount intended to be prepared.

2. The device as claimed in claim 1, comprising a pivoting system (7) constituted so as to allow the receptacle and/or the filtering membrane to pivot.

3. The device as claimed in claim 1, comprising means for recovering (8) the suspension, which are arranged so as to recover the suspension held in the receptacle when said receptacle is tipped.

4. The device as claimed in claim 2, comprising an object-carrying slide support (9) arranged such that the membrane is positioned above subsequent to it being tipped.

5. The device as claimed in claim 4, comprising means for injecting air in order to detach the membrane from its support and/or to attach the membrane to a slide which is on the object-carrying slide support, once the membrane is positioned on the object-carrying slide support.

6. The device as claimed in claim 4, comprising a mass (10) for pressing the filtrate of the suspension onto a slide placed on the object-carrying slide support.

7. The device as claimed in claim 6, comprising means (11) for applying the mass onto a slide for a predetermined period of time and for removing the mass automatically once said period of time has come to an end.

8. The device as claimed in claim 6, characterized in that the mass comprises a detachable component (12) so as to be able to use, where appropriate, a lighter mass.

9. The device as claimed in claim 1, characterized in that the receptacle (3) is of frustoconical shape, its cross section decreasing toward the base (4), the base comprising an opening (13) bordered on its external face by a protrusion (14) intended to ensure a leak-tight contact between the receptacle and the suction system.

10. The device as claimed in claim 1, comprising a system for conveying a fixing product (15) into the receptacle.

11. A set of devices as claimed in claim 1, arranged on the same piece of apparatus.

12. The device or set as claimed in claim 12, included in a box equipped with a cover.

13. A process for preparing a cytological preparation on an object-carrying slide (2) from a sample in the form of a suspension of cells, the process comprising a step during which a suspension is poured into a receptacle (3) and then suctioned/filtered through a filtering membrane (5) placed on a support (6) via an opening (13) placed on the base (4) of the receptacle, said process being characterized in that a predetermined fraction of the suspension of cells held in the receptacle is suctioned/filtered, said fraction corresponding to the amount intended to be prepared.

14. The process as claimed in claim 13, characterized in that, subsequent to the suction/filtration step, the receptacle (3) is pivoted and its contents recovered in recovering means (8).

15. The process as claimed in claim 14, characterized in that the filtering membrane (5) is pivoted so as to be positioned on an object-carrying slide support (9).

16. The process as claimed in claim 15, characterized in that air is injected in order to detach the membrane (5) from its support (6) and/or to attach the membrane to a slide (2) which is on the object-carrying slide support (9).

17. The process as claimed in claim 16, characterized in that a mass (10) is applied to the membrane (5) for a predetermined period of time in order to improve its adhesion to the slide (2) and that, once the predetermined period of time has come to an end, the mass is automatically removed.

18. The process as claimed in claim 17, characterized in that the activation of the mass triggers the cleaning of the membrane support (6).

19. The process as claimed in claim 13, characterized in that, prior to the suction/filtration step, a fixing product is introduced into the suspension held in the receptacle.
